(19) United States
(12) Patent Application Publication
(10) Pub. No.: US 2008/0093278 A1
(43) Pub. Date: Apr. 24, 2008

(54) Fluid treatment method and apparatus

(76) Inventor: DeJon Costello, Port Moody (CA)

Correspondence Address: NEXUS LAW GROUP LLP, 1500 - 701 WEST GEORGIA STREET, VANCOUVER, BC, V7Y 1C6, US

(21) Appl. No.: 11/505,381

(22) Filed: Aug. 17, 2006

(51) Int. Cl. B01D 63/02; B01D 53/02; B01D 53/04; B01D 15/08

(52) U.S. Cl. 210/109; 55/413; 96/152; 210/656; 210/500.23; 95/82

(57) ABSTRACT

Separator apparatus for removing an impurity or contaminant, such as oil or heavy metals, from a fluid, such as a liquid or a gas, comprises a body member having a fluid inlet and a fluid outlet, a fluid flow channel for the flow of fluid through the body member from the fluid inlet to the fluid outlet, a plurality of perforated or fluid pervious hollow members, such as spheres or balls, located in the fluid flow channel, wherein at least some of the hollow members contain a fluid treatment medium capable of removing the impurity or contaminant from the fluid as the fluid flows through the fluid flow channel. A fluid pervious or perforated hollow member loaded with a fluid treatment medium is also provided. A method for removing an impurity from a fluid is further provided.

### FIELD OF THE INVENTION

This invention relates to the treatment of a fluid, such as a gas or a liquid, for the removal of impurities therefrom, e.g. the removal of oil from water.

### BACKGROUND OF THE INVENTION

A serious pollution problem is caused by the run-off of contaminated water from paved surfaces, such as streets and parking lots, as well as other locations where the water is polluted with hydrocarbons, such as oil, grease and other contaminants, such as heavy metals.

A problem with conventional oil/water separating systems, also known as oil-grit separators, which are situated in locations for receiving the run-off water, is that they become clogged with debris, such as leaves, twigs and other trash in the water. Additionally, such systems are only capable of collecting a limited quantity of oil. In fact, it has been found that such separating systems are not effective in removal of oil from run-off water.

It is accordingly an object of the present invention to provide a treatment system which is less easily prone to clogging, as well as being capable of more efficiently removing contaminants from a fluid being treated.

### SUMMARY OF THE INVENTION

According to the invention there is provided a separator apparatus for removing an impurity or contaminant from a fluid, comprising a body member having a fluid inlet and a fluid outlet; a fluid flow channel for the flow of fluid through the body member from the fluid inlet to the fluid outlet; a plurality of perforated or fluid pervious hollow members located in the fluid flow channel, wherein at least some of the hollow members contain a fluid treatment medium capable of removing the impurity or contaminant from the fluid as the fluid flows through the fluid flow channel. At least some of the hollow members are preferably in contact with one another and shaped so as to provide interstitial spaces between the contacting hollow members in the flow channel of the body member. The hollow members may be spherical in shape.

The fluid may be a liquid, such as water or it may be a gas, such as air.

The body member may be in the form of a cylinder having an upper end and an open lower end, the fluid inlet comprising the open lower end and wherein the cylinder is provided with a transversely extending conduit located towards the upper end, which conduit is in fluid communication with the flow channel in the cylinder, and the fluid outlet comprising said conduit.

Also according to the invention there is provided a separator apparatus for removing oil from water, comprising a body member having a water inlet and a water outlet; a flow channel for the flow of water through the body member form the water inlet to the water outlet; a plurality of perforated hollow members located in the water flow channel, wherein at least some of the hollow members are in contact with one another and shaped so as to provide interstitial spaces between the contacting members in the bed; and wherein at least some of the hollow members contain an oil absorbent or adsorbent material for removing oil from the water.

Further according to the invention there is provided a method of removing an impurity or contaminant from a fluid, comprising the steps of providing a bed or column of perforated or fluid pervious hollow members, wherein at least some of the hollow members contain a treatment medium capable of removing the impurity or contaminant from the fluid; and causing the fluid to flow through the bed or column of hollow members whereby at least a part of the impurity or contaminant is removed from the fluid by the treatment medium.

Also according to the invention there is provided a method of removing an impurity or contaminant from a gas, comprising the steps of passing the gas through a water reservoir for transferring impurities or contaminants from the gas to the water in the reservoir providing a bed of perforated or water pervious hollow members, wherein at least some of the hollow members contain a treatment medium capable of removing the impurities or contaminants from the water in the reservoir and causing the water to flow from the reservoir through the bed of hollow members for removing at least part of the impurities or contaminants from the water by the treatment medium.

The invention also extends to a hollow member loaded with a fluid treatment medium for use in the apparatus or method.

Further objects and advantages of the invention will become apparent from the description of preferred embodiments of the invention below.

### BRIEF DESCRIPTION OF THE DRAWINGS

The invention will now be described, by way of examples, with reference to the accompanying drawings, in which:

FIG. 1 is a side view of a perforated hollow sphere for containing a liquid treatment agent;

FIG. 2 is a three-dimensional view of a liquid treatment apparatus using a plurality of the spheres of FIG. 1;

FIG. 3 is a sectional side view showing the liquid treatment apparatus of FIG. 2 installed in a conventional oil/water separator;

FIG. 4 is a sectional side view showing the liquid treatment apparatus of FIG. 2 installed in a conventional street or parking lot catch basin;

FIG. 5 is a sectional side view of another treatment apparatus using a plurality of the spheres of FIG. 1;

FIG. 6 is a section taken along the lines VI-VI in FIG. 5; and

FIG. 7 is a diagrammetrical illustration of an air or gas treatment apparatus using a plurality of the spheres of FIG. 1.

### DETAILED DESCRIPTION OF THE PREFERRED EMBODIMENTS

In the following description, certain specific details are set forth in order to provide a thorough understanding of various embodiments of the invention. However, one skilled in the art will understand that the present apparatus/method has additional embodiments, and/or may be practiced without at least some of the details set forth in the following description of preferred embodiment(s). In other instances, well known structures associated with the technology have not been described in detail to avoid unnecessarily obscuring the descriptions of the embodiments of the invention.

Unless the context requires otherwise, throughout the specification and claims which follow, the word “comprise” and variations thereof, such as “comprises” and “comprising” are to be construed in an open, inclusive sense, that is as “including but not limited to.”

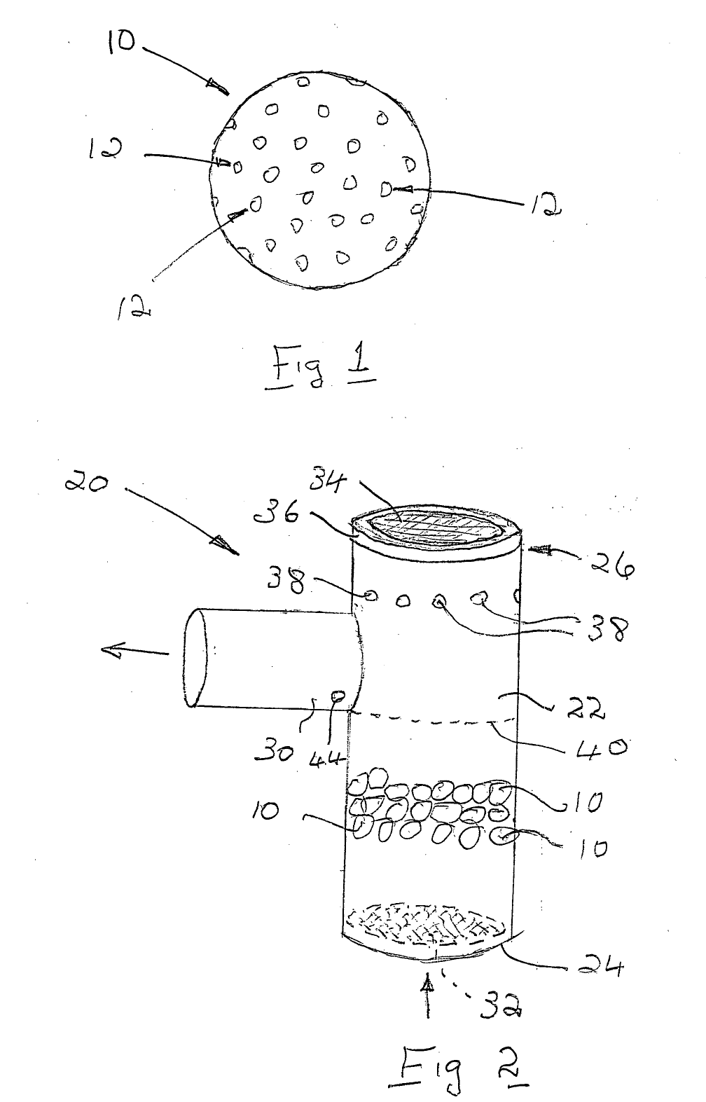

Referring now to FIG. 1 of the drawings, reference numeral 10 generally indicates a hollow sphere or ball which is provided with a plurality of holes or openings 12 spread over its surface.

The sphere 10 is packed with a liquid treatment agent or medium. In the present example, which relates specifically to the removal of hydrocarbons, such as grease and oil, as well as heavy metals, from water, the treatment agent is a suitable oleophilic absorbent/adsorbent material which is capable of removing such contaminants from the water. In applications where the contaminants comprise ions, the treatment agent may comprise an ion exchange resin. Such treatment agents are commercially available. Examples of such materials are zeolites, expanded perlite and vermiculite.

In practice, the perforated sphere 10 is provided with a filler opening (not shown) through which the sphere 10 is filled with the treatment agent in the form of a particulate material and then the filler opening is capped or sealed to retain the material inside the sphere 10. Preferably, the filler opening has a removable cap so that spent material can be removed after use and the sphere 10 cleaned and refilled with fresh material for re-use of the sphere 10. Alternatively, the sphere 10 can be provided in two halves which screw together.

The sphere 10 is of an oil attracting (oleophilic) material, such as polyethylene.

The sphere 10 loaded with the treatment agent can be used in a variety of different ways. In one particular example, the loaded spheres 10 are packed in a column, as shown in FIG. 2.

In FIG. 2 reference numeral 20 generally indicates a liquid treatment apparatus or separator comprising a cylindrical body member 22 which has an open lower end 24 and an open upper end 26 and an outlet pipe 30. The cylindrical member 22 is provided with a mesh screen 32 of stainless steel at its lower end 24. At its upper end 26, it is also provided with a mesh screen 34. The screen 34 is located on a removable cap 36 which fits onto the upper end 26. With this arrangement water can pass through both the lower end upper ends 24,26 while longer items of trash in the water will be filtered out by the mesh screens 32,34.

The cylindrical member 22, which is of a material which is resistant to hydrocarbons, e.g. PVC, is also provided with a plurality of openings 38 extending circumferentially around the cylindrical member 22 at a location just above the level of the outlet pipe 30.

The cylindrical member 22 is filled with a plurality of the loaded spheres 10 up to the level of the outlet pipe 30, as indicated by the broken line 40 in FIG. 2. Conveniently the spheres 10 are contained in a bag of netting material (not shown) which is placed inside the cylindrical member 22. In order to prevent the spheres 10 from escaping through the outlet pipe 30 should the bag of netting material break, a retainer screen (not shown) can be located at line 40.

The spheres 10 form a column in the cylindrical member 22 in which the spheres 10 are arranged in successive layers along the length of the cylindrical member 22 and with interstitial spaces between adjacent spheres. These spaces form tortuous flow channels through the column of spheres 10. The flow channels facilitate the passage of leaves, twigs and other debris present in the water, through the column, i.e. clogging of the column is counteracted. Therefore, in cases where the water contains a high amount of suspended solids, passage of the water through the column of spheres 10 is still possible in contrast with conventional filters which become clogged as a result of the suspended material.

A test port 44, which may be valve controlled, is provided on the outlet pipe 30 for drawing water from the separator 20 for testing purposes, e.g. to investigate the effectiveness of the treatment process.

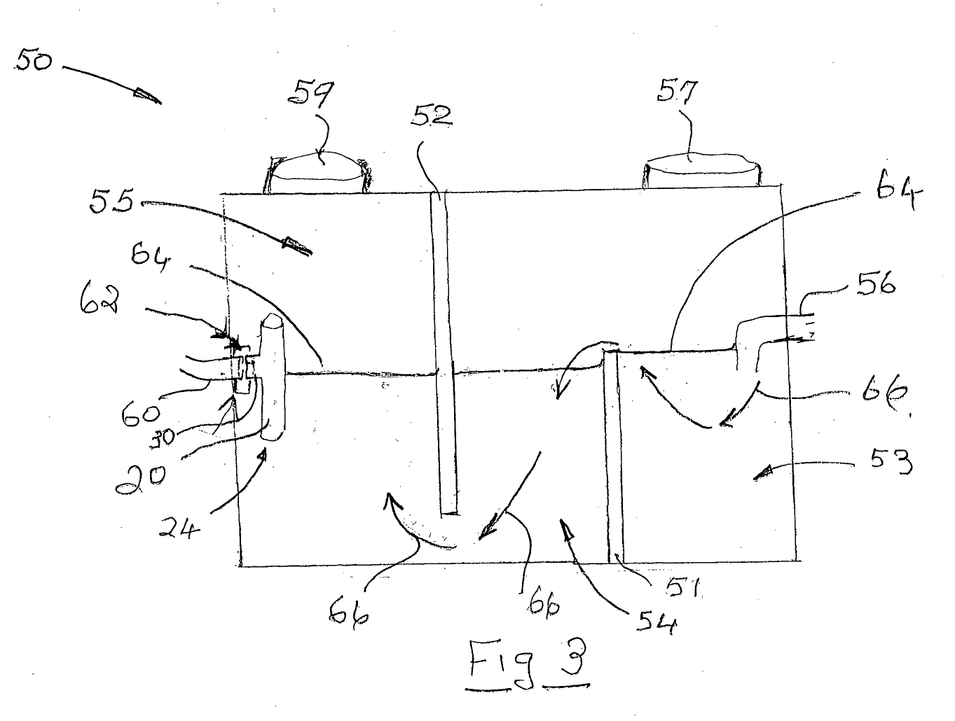

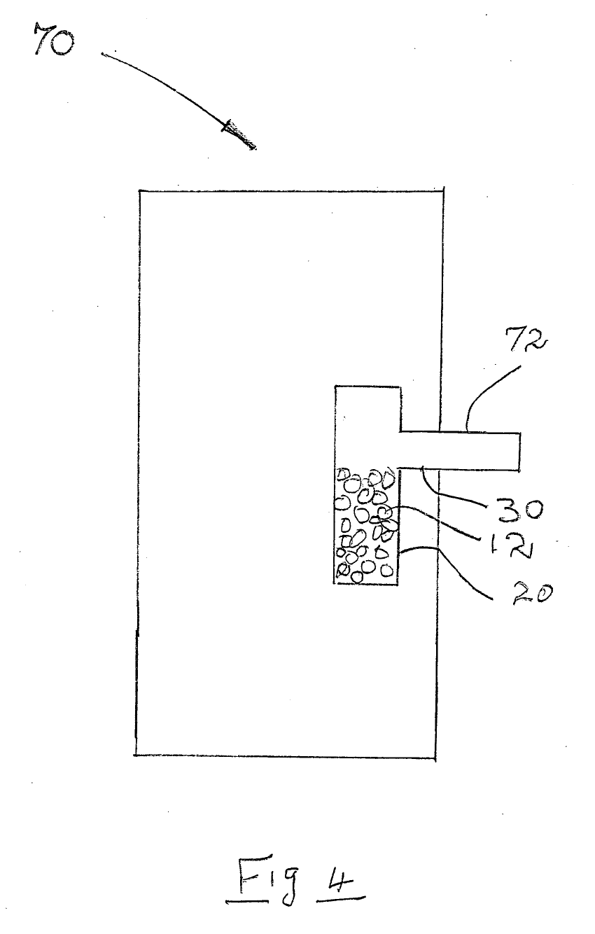

The separator 20 can be used in a variety of installations. In the example shown in FIG. 3, the separator 20 is installed in a conventional oil/water separator 50.

The separator 50 is of the type that is installed at paved locations, such as parking lots for receiving run-off water. As mentioned earlier, such water is normally contaminated with oil/grease, as well as other contaminants, such as heavy metals.

Typically the separator 50 has two concrete water baffles 51 and 52 which divide the separator 50 into three chambers 53, 54 and 55. Access covers 57 and 59 are provided for servicing the separator 50. The separator 50 has an inlet pipe 56 and an outlet pipe 60. As can be seen, the arrangement is such that contaminated water entering through the inlet pipe 56 first enters the chamber 53. As the chamber 53 fills, the water flows over the baffle 51 and into the chamber 54. The first chamber 53 merely serves as a settling tank for the settling of sand and other solids in the water.

As shown, the outlet pipe 30 of the separator 20 is connected to the outlet pipe 60 of the separator 50 by means of a connecting clamp 62. If desired, a supporting member, such as a brace (not shown), can be provided to assist in mounting the separator 20 against the inner wall of the chamber 55.

As shown, water from the chamber 54 passes underneath the barrier 52 to enter the chamber 55. The water level in the chambers 53, 54 and 55 during operations of the separator 50 is indicated by line 64 and the general flow of water through the separator 50 by the arrows 66.

Water in the chamber 55 enters the separator 20 through its open lower end 24 flows upwardly through the column of loaded spheres 10 in the separator 20 to exit through the outlet pipe 30 which is in communication with the outlet pipe 60 of the separator 50.

In its passage upwards through the column of loaded spheres 10, the emulsified oil in the water is disturbed and agitated due to the holes 12 in the spheres 10. The perforated spheres 10 assist in coalescing of the emulsified oil. The oil adheres to the surfaces of the spheres 10 resulting in the oil coalescing into droplets. Natural coalescing occurs in that droplets mate with droplets to form larger droplets which enter the spheres 10 through the holes 12 and are absorbed by the absorbent/adsorbent material in the spheres 10. At the same time, it has been found that the other contaminates, such as heavy metals are also removed from the water by the action of the loaded spheres 10. Tests that have been conducted on water samples taken from the top of the column have shown that there is a significant reduction of the oil in the water, as well as of the heavy metals.

If it should occur that there is a large obstruction in the water, e.g. a plastic bag, the inlet 32 may be partially or totally obscured resulting in the water level in the chamber 55 to rise.

In such a case water can enter through the openings 38 and exit through the outlet 30. Should the obstruction be so severe or the inflow of water into the chamber 55 be very rapid, e.g. on a result of a flood, water can also enter through the screen 34 at the top 26 of the cylinder 22. In this way flooding of the separator 50 and surrounding area is counteracted.

The separator 20 may also be installed in a so-called water/grit separator, which typically has two chambers, namely a first chamber in which solid material, such as sand and grit, is allowed to settle out and a second chamber into which water from the first chamber overflows. The separator 20 is connected to a water outlet in the second chamber in similar fashion as in FIG. 3 and is not again illustrated.

In another application, as illustrated in FIG. 4, the separator 20 is installed in a conventional street or parking lot catch basin 70.

The separator 20 may be mounted to the inside of the catch basin 70 in any suitable fashion with the outlet pipe 30 connected to an outlet 72 which is in communication with a drain.

As the water level inside the catch basin 70 rises, water will flow upwards through the column of loaded spheres 10 in the separator 20 and water/oil separation and heavy metal removal takes place, as described with respect to the example shown in FIG. 3.

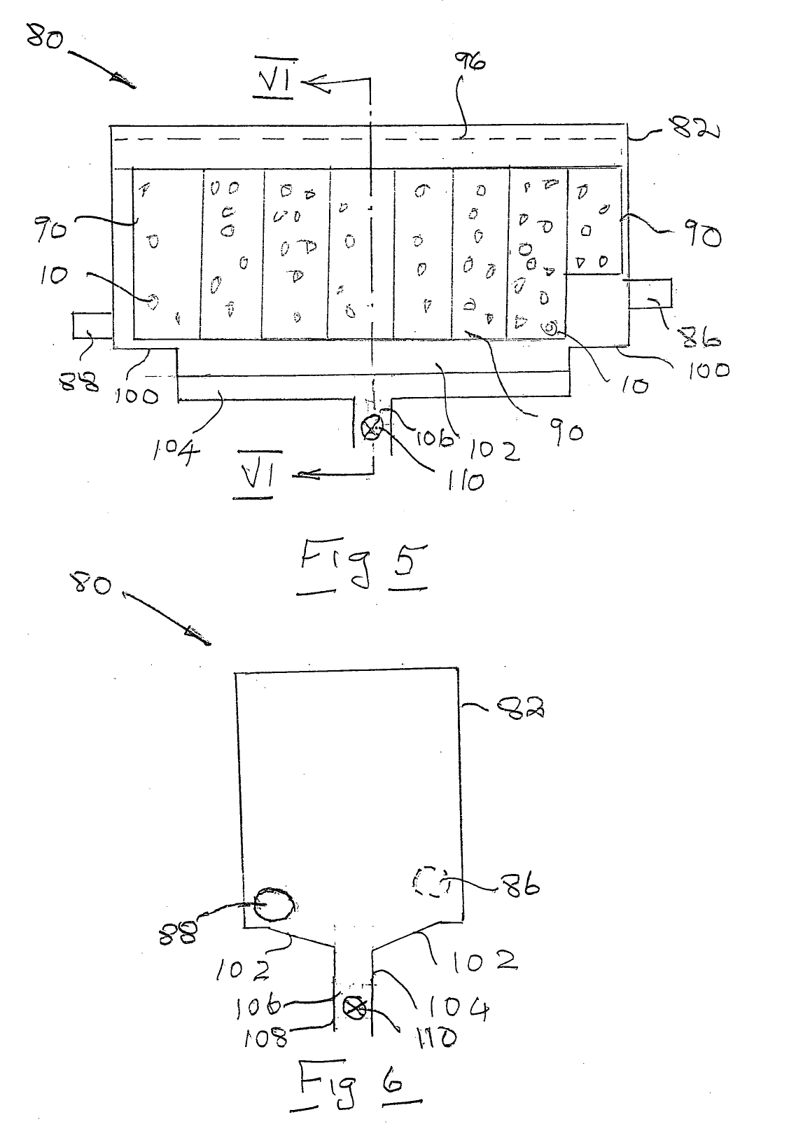

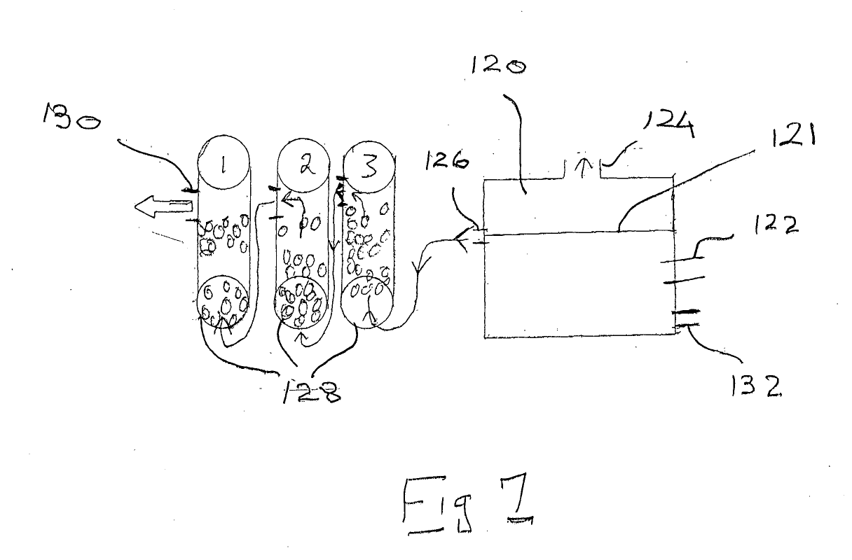

In another application, as illustrated in FIGS. 5 and 6, the loaded spheres 10 are placed in a separator 80 which is in the form of a rectangular container 82 with a removable lid. The container 82 further has an inlet pipe 86 and an outlet pipe 88.

For convenience, the loaded spheres 10 are contained in a plurality of trays 90 of meshed material. Brackets or guide rails are provided inside the container 82 for removably supporting the trays 90 inside the container 82. This provides for easy placement and removal of the trays 90, e.g. for replacing the spheres 10.

As can be seen, the tray 90 at the inlet end of the container 82 is at a higher level than the remaining trays 90. This provides a space for the inlet water to chum and provide for easier separation of suspended solids.

The broken line 96 in FIG. 5 indicates the water level in the separator 80 when in operation. It will be seen that this provides for a water column above the trays 90 containing the spheres 10. This allows for heavy oil that may be present in the water to come to the surface where it can be removed, either manually or by a mechanical skimmer. In one application, a free water space of about 6 inches is provided above the trays 90.

In the view shown in FIG. 6, which is facing the outlet end of the container 82, the position of the inlet 86 is shown in broken lines. As can be seen, the inlet 86 and outlet 88 are located towards opposite sides of the container 82, with the inlet situated at a higher level than the outlet 88.

In one application, a clearance space of about 4 inches is provided between the bottoms of the trays 90 and the bottom of the container 82.

In the example shown in FIGS. 5 and 6, the bottom of the container 82 is configured to provide a pair of flat surfaces 100 to provide separation areas for solids that may be present in the water such as sand and gravel, to settle out.

In addition, a pair of sloping surfaces 102 leading to a drain trench 104 is provided. A drain chute or opening 106 is provided centrally of the container 82 in the drain trench 104. The chute 106 is connected to a drain pipe 108 via a dump valve 110. This is provided for purging the container 82 to remove solids, such as sand, that has settled on the bottom of the container 82.

In one example, the trench 104 is about 2 inches wide and the chute 106 is about 3 inches wide.

In use, contaminated water to be treated is pumped through the separator 80. The separator 80 may, for example, be used where there has been an oil spill in water, such as in a harbour.

Water entering the container 82 flows in under the trays 90 over the flat surface 100. By maintaining the water at the level 96, water will percolate through the loaded spheres 10 in the trays 90, whereby oil and other contaminants, such as heavy metals, are removed, as previously described.

In another application, the apparatus may be operated in a closed circuit, i.e. the water being treated may be repeatedly passed through a column or bed of the loaded spheres 10. Such an apparatus may be located on a truck which can be driven to a location where water treatment is required.

In another application, a number of columns or beds of the loaded spheres 10 may be connected in series in which case the water being treated will pass through the columns or beds in succession.

In one such application, as shown in FIG. 7, the method and apparatus may be used for the removal of air-borne pollutants.

The apparatus comprises a tank 120 having an inlet 122 for polluted air, e.g. exhaust, and an air vent 124 for the release of treated air to the atmosphere. The tank 120 is filled with water to form a water bath. During operation the water level in the tank 120 is as shown at 121. The tank 120 further has a water outlet 126 which is connected to the bottom of a first in a series of columns 128 of loaded spheres 10. In the present example, three columns 128 are shown.

The water is pumped to percolate upwardly through the first column 128. Water exiting from the top of the first column 128 enters the bottom of the second column 128 and then percolates upwards through the second column 128. The water then flows from the top of the second column 128 to the bottom of the third column 128 and then flows upward through the third column 128. Water exiting from the top of the third column is recirculated to the tank 120 via an outlet 130 and re-enters the tank 120 through an inlet 132.

By passing polluted air through the water bath, pollutants in the air are stripped from the air by the water and the water becomes contaminated. By circulating the water through the column 128 of loaded spheres 10, as described above, the water is purified.

A further possible application of the hollow spheres comprises simply dropping a number of the loaded spheres 10 into a boat bilge. In a larger vessel, the bilge water can be treated by pumping the water through a series of packed columns similar as shown in FIG. 7.

In another application a number of the spheres 10, e.g. 6 to 10, can be tethered together, e.g. by a stainless steel wire that is threaded through the openings 12 in the spheres 10, thereby connecting the spheres 10 together. Such an assembly of spheres 10 can then be used by simply dropping it into an area where it is to be used, e.g. in a parking lot catch basin.

It will be appreciated that the method and apparatus can be applied in a variety of other applications, apart from the oil/water separation described by way of examples above. For instance, it may be applied for the removal of heavy metals or other contaminants where oil removal is not required, e.g. the removal of mercury from the waste water generated by a dental practitioner. It may further be applied to the removal of contaminants from liquids other than water. It may also be applied for the removal of contaminants from fluids other than liquid, such as gases. For example, it may be applied for the removal of contaminants from air in combating air pollution, as described with reference to FIG. 7 above. In each application, the treatment agent or medium will be selected according to the particular fluid/contaminant system involved. For example, a medium that is known for its ability to remove oil from water will be selected where oil/water separation is required. For heavy metal removal, a medium that is known for its ability to achieve this purpose will be selected. In some applications more than one medium may be required to achieve a particular purpose. In such cases the spheres 10 may be filled with two or more different media or some of the spheres 10 may be filled with one medium, while some of the other spheres 10 are filled with another medium, so that different spheres 10 containing different media are used together.

The claims which follow are to be considered an integral part of the present disclosure. Although certain preferred embodiments of the present invention have been shown and described in detail, it should be understood that various changes and modifications may be made therein without departing from the scope of the appended claims. In general, in the following claims, the terms used should not be construed to limit the invention to the specific embodiments disclosed in the specification, but should be construed to include all methods and apparatuses that operate in accordance with the claims. Accordingly, the invention is not limited by the disclosure, but instead its scope is to be determined entirely by the following claims.

I claim:

1. Separator apparatus for removing an impurity or contaminant from a fluid comprising:
a body member having a fluid inlet and a fluid outlet;
a fluid flow channel for the flow of fluid through the body member from the fluid inlet to the fluid outlet;
a plurality of perforated or fluid pervious hollow members located in the fluid flow channel, wherein
at least some of the hollow members contain a fluid treatment medium capable of removing the impurity or contaminant from the fluid as the fluid flows through the fluid flow channel.

2. The apparatus according to claim 1, wherein at least some of the hollow members are in contact with one another and shaped so as to provide interstitial spaces between the contacting hollow members in the flow channel of the body member.

3. The apparatus according to claim 2, wherein the hollow members are substantially spherical in shape.

4. The apparatus according to claim 1, wherein the fluid is a liquid.

5. The apparatus according to claim 4, wherein the fluid is water.

6. The apparatus according to claim 1, wherein the fluid is a gas.

7. The apparatus according to claim 6, wherein the fluid is air.

8. The apparatus according to claim 5, wherein the contaminant comprises a hydrocarbon.

9. The apparatus according to claim 8, wherein the contaminant is oil.

10. The apparatus according to claim 9, wherein the contaminant also comprises a heavy metal.

11. The apparatus according to claim 9, wherein the treatment medium comprises a particulate solid material which is a liquid hydrocarbon absorbent or adsorbent.

12. The apparatus according to claim 1, wherein the contaminant comprises a heavy metal.

13. The apparatus according to claim 1, wherein the body member is in the form of a cylinder having an upper end and an open lower end, the fluid inlet comprising the open lower end and wherein the cylinder is provided with a transversely extending conduit located towards the upper end, which conduit is in fluid communication with the flow channel in the cylinder, and the fluid outlet comprising said conduit.

14. The apparatus according to claim 13, wherein the hollow members are stacked inside the cylinder to form a column of the hollow members in the cylinder.

15. The apparatus according to claim 14, wherein the fluid inlet is provided with a screen of meshed material for the passage of the water therethrough.

16. The apparatus according to claim 13, wherein the upper end of the cylinder is open.

17. The apparatus according to claim 16, wherein the upper end of the cylinder is provided with a screen of meshed material.

18. The apparatus according to claim 13, wherein the cylinder is provided with a plurality of circumferentially spaced openings located between the transversely extending conduit and the upper end of the cylinder.

19. The apparatus according to claim 1, wherein the hollow members are contained in a bag of meshed or netted material inside the body member.

20. The apparatus according to claim 1, wherein the body member is in the form of a rectangular container, wherein a bed of the hollow members is provided in the container for the flow of fluid therethrough.

21. The apparatus according to claim 20, wherein the hollow members are contained in at least one tray of a netted or meshed material, which tray is slidingly removable from the container.

22. A perforated or fluid pervious hollow member containing a fluid treatment medium for use in the apparatus of claim 1.

23. The hollow member according to claim 22, wherein the member is substantially spherical in shape.

24. The hollow member according to claim 22, wherein the member is of an oleophilic material.

25. Separator apparatus for removing oil from water, comprising:
a body member having a water inlet and a water outlet;
a flow channel for the flow of water through the body member form the water inlet to the water outlet;
a plurality of perforated hollow members located in the water flow channel,
wherein at least some of the hollow members are in contact with one another and shaped so as to provide interstitial spaces between the contacting members in the bed; and
wherein at least some of the hollow members contain an oil absorbent or adsorbent material for removing oil from the water.

26. The apparatus according to claim 25, wherein the hollow members are substantially spherical in shape.

27. The apparatus according to claim 25, wherein the oil absorbent or adsorbent material is in the form of a particulate solid material.

28. The apparatus according to claim 25, wherein the body member is in the form of a cylinder having an upper end and an open lower end, the water inlet comprising the open lower end and wherein the cylinder is provided with a transversely extending conduit located towards the upper end, which conduit is in fluid communication with the flow channel in the cylinder, and the water outlet comprising said conduit.

29. The apparatus according to claim 28, wherein the hollow members are stacked inside the cylinder to form a column of the hollow members in the cylinder.

30. A perforated or fluid pervious hollow member containing an oil absorbent or adsorbent material for use in the apparatus of claim 25.

31. The hollow member according to claim 30, wherein the member is substantially spherical in shape.

32. A method of removing an impurity or contaminant from a fluid comprising the steps of:
providing a bed or column of perforated or fluid- pervious hollow members, wherein at least some of the hollow members contain a treatment medium capable of removing the impurity or contaminant from the fluid; and
causing the fluid to flow through the bed or column of hollow members whereby at least a part of the impurity or contaminant is removed from the fluid by the treatment medium.

33. The method according to claim 32, wherein at least some of the hollow members are in contact with one another and shaped so as to provide interstitial spaces between the contacting members in the bed.

34. The method according to claim 33, wherein the hollow members are substantially spherical in shape.

35. The method according to claim 32, wherein the fluid is water and the contaminant is oil.

36. The method according to claim 32, wherein the contaminant comprises a heavy metal.

37. A perforated or fluid pervious hollow member containing a fluid treatment medium for use in the method of claim 32.

38. The hollow member according to claim 37, wherein the member is substantially spherical in shape.

39. A method of removing an impurity or contaminant from a gas, comprising the steps of:
passing the gas through a water reservoir for transferring impurities or contaminants from the gas to the water in the reservoir;
providing a bed of perforated or water pervious hollow members, wherein at least some of the hollow members contain a treatment medium capable of removing the impurities or contaminants from the water in the reservoir; and
causing the water to flow from the reservoir through the bed of hollow members for removing at least part of the impurities or contaminants from the water by the treatment medium.

40. The method according to claim 38, wherein the water is recycled from the bed of hollow members to the reservoir.

41. The method according to claim 38, wherein the gas is air.
